(19) United States
(12) Patent Application Publication
(10) Pub. No.: US 2026/0265931 A1
(43) Pub. Date: Sep. 10, 2026

(54) CATHODE CATALYST LAYER AND MEMBRANE ELECTRODE ASSEMBLY

(71) Applicant: TOYOTA JIDOSHA KABUSHIKI KAISHA, Toyota-shi (JP)

(72) Inventor: Keiichi OKUBO, Toyota-shi (JP)

(21) Appl. No.: 19/463,385

(22) Filed: Jan. 29, 2026

(30) Foreign Application Priority Data
Mar. 7, 2025 (JP) 2025-036445

(51) Int. Cl. C25B 9/23; C25B 1/04; C25B 11/032; C25B 11/065; C25B 11/081; C25B 13/08

(52) U.S. Cl. CPC C25B 9/23; C25B 1/04; C25B 11/032; C25B 11/065; C25B 11/081; C25B 13/08

(57) ABSTRACT

The present disclosure relates to a cathode catalyst layer included in a water electrolysis cell. The cathode catalyst layer includes a cathode catalyst and a fibrous material. The proportion of the mass of the fibrous material to the total mass of the cathode catalyst and the fibrous material is 35.0% to 60.0%.

### CROSS-REFERENCE TO RELATED APPLICATION

This application claims priority to Japanese Patent Application No. 2025-036445 filed on Mar. 7, 2025. The disclosure of the above-identified application, including the specification, drawings, and claims, is incorporated by reference herein in its entirety.

### BACKGROUND

### 1. Technical Field

The present disclosure relates to cathode catalyst layers and membrane electrode assemblies for use in water electrolysis cells.

### 2. Description of Related Art

Water electrolysis cells for producing hydrogen and oxygen by electrolysis of water are conventionally known in the art. Such a water electrolysis cell includes, for example, a membrane electrode assembly in which an anode catalyst layer that generates oxygen is laminated on a first surface of a solid polymer electrolyte membrane and a cathode catalyst layer that generates hydrogen is laminated on a second surface of the solid polymer electrolyte membrane.

For example, Japanese Unexamined Patent Application Publication No. 2023-174340 (JP 2023-174340 A) discloses an electrode catalyst layer formed on a solid polymer electrolyte membrane. The electrode catalyst layer contains a catalyst and a polymer electrolyte, and has an electrode surface porosity of 1.0% or more and 20% or less at the surface opposite to the surface in contact with the polymer electrolyte membrane.

### SUMMARY

The electrode catalyst layer disclosed in JP 2023-174340 A is intended to suppress retention of oxygen gas generated within the electrode catalyst layer during electrolysis by adjusting the electrode surface porosity. As a result, the cell voltage during electrolysis can be reduced and durability can be improved.

However, in the electrode catalyst layer disclosed in JP 2023-174340 A, the hydrogen concentration in the cathode increases during water electrolysis. The resulting concentration gradient serves as a driving force that causes hydrogen to permeate from the cathode to the anode, and as a result, the hydrogen concentration on the anode side may reach the explosion limit (4% in oxygen), posing a safety risk. In addition, hydrogen activated at the cathode permeates to the anode, resulting in a decrease in the amount of hydrogen recovered from the cathode. Therefore, the electrode catalyst layer disclosed in JP 2023-174340 A is insufficient in reducing the amount of hydrogen migration to the anode and still has room for improvement.

Accordingly, in view of the above circumstances, an object of the present disclosure is to provide a cathode catalyst layer that suppresses hydrogen permeation from the cathode to the anode, exhibits high safety, and enables a large amount of hydrogen to be recovered, and a membrane electrode assembly including the cathode catalyst layer.

The present inventors have found that adding a predetermined amount of a fibrous material such as carbon fibers to the cathode catalyst layer promotes hydrogen diffusion in the cathode and suppresses hydrogen permeation to the anode. The present disclosure has been achieved based on this finding. The gist of the present disclosure is as follows.
(1) A cathode catalyst layer included in a water electrolysis cell includes: a cathode catalyst; and a fibrous material, wherein the proportion of the mass of the fibrous material to the total mass of the cathode catalyst and the fibrous material is 35.0% to 60.0%.
(2) The cathode catalyst layer according to (1), wherein the fibrous material is carbon fibers.
(3) The cathode catalyst layer according to (1), wherein the cathode catalyst contains platinum.
(4) A membrane electrode assembly for a water electrolysis cell, the membrane electrode assembly including:
an electrolyte membrane; an anode catalyst layer laminated on a first surface of the electrolyte membrane; and the cathode catalyst layer according to (1), the cathode catalyst layer being laminated on a second surface of the electrolyte membrane.
(5) The membrane electrode assembly according to (4), wherein the electrolyte membrane has a thickness of 20 μm or less.

In the present disclosure, the cathode catalyst layer contains a predetermined amount of a fibrous material. Accordingly, hydrogen diffusion in the cathode can be promoted, and as a result, hydrogen permeation to the anode can be suppressed. Therefore, the present disclosure can provide a membrane electrode assembly that has high safety and enables a large amount of hydrogen to be recovered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between the content of a fibrous material in the cathode catalyst layer and the hydrogen concentrations in anode exhaust gas before and after a durability test.

### DETAILED DESCRIPTION OF EMBODIMENTS

The present disclosure will now be described in detail based on an embodiment.

First, the configuration of a water electrolysis cell including a cathode catalyst layer according to the present embodiment will be described. A water electrolysis cell is a device that decomposes water into hydrogen and oxygen, and a plurality of such water electrolysis cells is stacked to form a water electrolysis stack.

The water electrolysis cell has a multilayer structure in which an anode (oxygen evolution electrode) is disposed on one side of an electrolyte membrane and a cathode (hydrogen evolution electrode) is disposed on the other side of the electrolyte membrane. On the anode side, an anode catalyst layer, an anode gas diffusion layer, and an anode separator are laminated in this order from the side closer to the electrolyte membrane. On the cathode side, a cathode catalyst layer, a cathode gas diffusion layer, and a cathode separator are laminated in this order from the side closer to the electrolyte membrane. The membrane electrode assembly (MEA) refers to a laminate formed of an electrolyte membrane, an anode catalyst layer laminated on a first surface of the electrolyte membrane, and a cathode catalyst layer laminated on a second surface of the electrolyte membrane.

In the present embodiment, the electrolyte membrane is sandwiched between the anode and the cathode. The electrolyte membrane is a membrane formed of a polymer having ion exchange groups. For example, the polymer may have at least one selected from sulfonic acid groups, phosphoric acid groups, and quaternary ammonium groups as ion exchange groups. The electrolyte membrane may be an anion exchange membrane or a cation exchange membrane. For example, the electrolyte membrane may be formed of a perfluorocarbon sulfonic acid polymer, or a polymer mainly containing either polyether ether ketone or polybenzimidazole. Metals such as iridium, platinum, cerium, and manganese, or cations thereof, may be incorporated into the electrolyte membrane. When metal is incorporated into the electrolyte membrane, the metal loading in the electrolyte membrane may be 5 μg/cm² or less, or may be 3 μg/cm² or less. The metal contained in the electrolyte membrane may be in the form of a metal, an oxide, or ions. In the present embodiment, the electrolyte membrane is a proton (hydrogen ion) exchange membrane.

The anode includes an anode catalyst layer and an anode gas diffusion layer. The anode catalyst layer is laminated on a first surface of the electrolyte membrane. In the stacking direction of the water electrolysis cell, the anode gas diffusion layer is laminated on the surface of the anode catalyst layer opposite to the surface of the anode catalyst layer facing the electrolyte membrane.

The anode catalyst layer functions as an anode electrode that generates oxygen. In the present embodiment, the anode catalyst layer contains at least a binder or ionomer and an anode catalyst.

The anode catalyst is metal particles that catalyze an oxygen evolution reaction. For example, the anode catalyst may contain at least one metal selected from platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The anode catalyst preferably contains iridium. The anode catalyst may contain two or more of these metals. The anode catalyst preferably mainly contains either iridium or ruthenium. The anode catalyst may be, for example, an oxide, a nitride, a sulfide, or a phosphide. The anode catalyst is preferably either an oxide or a nitride. The anode catalyst may be formed of at least one selected from iridium particles, iridium alloy particles, and composite particles containing iridium. For example, the iridium alloy particles and the composite particles containing iridium may contain at least one metal selected from ruthenium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, in addition to iridium. The iridium alloy particles and the composite particles containing iridium may contain two or more of these metals. The content of elements other than iridium in the iridium alloy particles is not particularly limited, and for example, may be 0.11 atomic percent (at %) or more and 80 at % or less. The particle size of the metal particles constituting the anode catalyst is not particularly limited, and for example, may be 1 nm or more and 5000 nm or less. In the present embodiment, the particle size of the metal particles refers to the average crystallite size measured by X-ray diffraction. In another embodiment, the particle size of the metal particles may refer to the average particle size calculated by measuring the particle sizes of a predetermined number of metal particles with an electron microscope and averaging the measured particle sizes. To calculate the average particle size, the particle sizes of, for example, 100 to 1000 metal particles may be measured using an electron microscope.

The anode catalyst may be supported on a support. The method for supporting the anode catalyst on the support is not particularly limited, and for example, a known method such as an impregnation method may be used. The support on which the anode catalyst is supported may be in the form of primary particles or secondary particles. For example, the particle size of the primary particles constituting the support may be 5 nm or more and 5000 nm or less. The loading percentage of the anode catalyst supported on the support is not particularly limited, and for example, may be 1% or more, 50% or more, or 100% or less.

For example, the support on which the anode catalyst is supported may be formed of an oxide. For example, the oxide constituting the support may be at least one selected from titanium oxide, niobium oxide, tin oxide, tungsten oxide, and molybdenum oxide. The support on which the anode catalyst is supported may be formed of, for example, a mixture containing at least one of these oxides.

For example, the binder or ionomer may be formed of a polymer having ion exchange groups. For example, the binder may have at least one selected from sulfonic acid groups, phosphoric acid groups, and quaternary ammonium groups as ion exchange groups. The binder may be formed of an anion exchange polymer or a cation exchange polymer.

For example, the binder may be formed of a perfluorocarbon sulfonic acid polymer, or a polymer mainly containing either polyether ether ketone or polybenzimidazole.

The anode gas diffusion layer serves to distribute gas. For example, the anode gas diffusion layer may be formed of at least one selected from carbon paper, carbon fibers, carbon cloth, porous titanium, and titanium fibers. The anode gas diffusion layer may be formed of a combination of two or more of these materials. The anode gas diffusion layer may also include a microporous layer formed of either carbon or titanium particles, or both.

The cathode includes a cathode catalyst layer and a cathode gas diffusion layer. The cathode catalyst layer is laminated on a second surface of the electrolyte membrane. In the stacking direction of the water electrolysis cell, the cathode gas diffusion layer is laminated on the surface of the cathode catalyst layer opposite to the surface of the cathode catalyst layer facing the electrolyte membrane.

The cathode catalyst layer functions as a cathode electrode that generates hydrogen. In the present embodiment, the cathode catalyst layer contains at least a cathode catalyst and a fibrous material.

The fibrous material contained in the cathode catalyst layer may be, for example, carbon fibers, polymer fibers, oxide fibers, or metal fibers. One of these fibrous materials may be used alone, or two or more of them may be used in combination. Examples of the carbon fibers include carbon fibers, carbon nanotubes, carbon nanohorns, and vapor-grown carbon fibers (VGCFs). Examples of the polymer fibers include nanofibers of amine-based polymers having an imide structure or an azole structure, and nanofibers derived from perfluorocarbon sulfonic acid polymers. The polymer fibers are more preferably nanofibers of engineering plastics. It is preferable that the fibrous material neither dissolve in nor deteriorate due to the solution used for electrolysis, and that the fibrous material have heat resistance at temperatures higher than 120° C. With these physical properties, the fibrous material can be expected to exhibit stability in the cathode catalyst layer. In the present specification, the term “fibrous” refers to a material whose primary particles (the smallest units distinguishable as particles) have an aspect ratio of 10 or more, preferably 100 or more. Specifically, the aspect ratio is preferably in the range of 10 to 1000, and more preferably in the range of 10 to 100. The aspect ratio is herein defined as the ratio of the longest dimension of a primary particle to the shortest dimension of the primary particle (longest dimension of primary particle/shortest dimension of primary particle).

In the present embodiment, the proportion of the mass of the fibrous material to the total mass of the cathode catalyst and the fibrous material is 35.0% to 60.0%. Preferably, the proportion is in the range of 35.0% to 56.0%. When the proportion of the fibrous material is within the above range, the diffusion of hydrogen generated at the cathode is promoted, making it less likely that a concentration gradient occurs due to an increase in the hydrogen concentration in the cathode. As a result, the permeation of hydrogen to the anode is suppressed. Therefore, the risk of an increase in hydrogen concentration on the anode side can be reduced, and the amount of hydrogen recovered from the cathode side can also be increased.

The cathode catalyst is metal particles that catalyze a hydrogen evolution reaction. For example, the cathode catalyst may contain at least one metal selected from platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The cathode catalyst may contain two or more of these metals. The cathode catalyst may be, for example, an oxide, a nitride, a sulfide, or a phosphide. The cathode catalyst may be formed of at least one selected from platinum particles, platinum alloy particles, and composite particles containing platinum. For example, the platinum alloy particles and the composite particles containing platinum may contain at least one metal selected from ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, in addition to platinum. The platinum alloy particles and the composite particles containing platinum may contain two or more of these metals. The content of elements other than platinum in the platinum alloy particles is not particularly limited, and for example, may be 0.11 at % or more and 60 at % or less. The particle size of the metal particles constituting the cathode catalyst is not particularly limited, and for example, may be 1 nm or more and 100 nm or less.

The cathode catalyst may be supported on a support. The method for supporting the cathode catalyst on the support is not particularly limited, and for example, a known method such as an impregnation method may be used. The support on which the cathode catalyst is supported may be in the form of primary particles or secondary particles. For example, the particle size of the primary particles constituting the support may be 5 nm or more and 5000 nm or less. The loading percentage of the cathode catalyst supported on the support is not particularly limited, and for example, may be 1% or more, 18% or more, 48% or less, or 70% or less. For example, the support on which the cathode catalyst is supported may be formed of at least one selected from electrically conductive carbon, an oxide, and a mixture containing carbon and an oxide. For example, the carbon constituting the support may be at least one selected from carbon black such as acetylene black, Ketjenblack, and furnace black, activated carbon, graphite, glassy carbon, graphene, carbon fibers, carbon nanotubes, carbon nitride, sulfurized carbon, phosphorus-doped carbon, channel black, roller black, disc black, oil furnace black, gas furnace black, lamp black, thermal black, and Vulcan carbon. The support on which the cathode catalyst is supported may be formed of, for example, a mixture containing at least one of these carbons. The oxide constituting the support may be at least one selected from titanium oxide, niobium oxide, tin oxide, tungsten oxide, and molybdenum oxide. The support on which the cathode catalyst is supported may be formed of, for example, a mixture containing at least one of these oxides.

In the present embodiment, the cathode catalyst layer contains a binder or an ionomer. For example, the binder or the ionomer may be formed of a polymer having ion exchange groups. For example, the binder may have at least one selected from sulfonic acid groups, phosphoric acid groups, and quaternary ammonium groups as ion exchange groups. The binder may be formed of an anion exchange polymer or a cation exchange polymer.

For example, the binder may be formed of a perfluorocarbon sulfonic acid polymer, or a polymer mainly containing either polyether ether ketone or polybenzimidazole.

The cathode gas diffusion layer serves to distribute gas. For example, the cathode gas diffusion layer may be formed of at least one selected from carbon paper, carbon fibers, carbon cloth, porous titanium, and titanium fibers. The cathode gas diffusion layer may be formed of a combination of two or more of these materials. The cathode gas diffusion layer may also include a microporous layer formed of either carbon or titanium particles, or both.

In the water electrolysis cell described above, hydrogen and oxygen are generated from water. Specifically, when current is applied between the anode and the cathode, water supplied to the anode through a flow channel of the anode separator is decomposed into oxygen, electrons, and protons in the anode catalyst layer under an applied potential. The protons migrate through the electrolyte membrane to the cathode catalyst layer. The electrons separated in the anode catalyst layer reach the cathode catalyst layer through an external circuit. Hydrogen is then generated in the cathode catalyst layer when the protons receive electrons. The generated hydrogen reaches the cathode separator and is discharged through a flow channel of the cathode separator. The oxygen separated in the anode catalyst layer reaches the anode separator and is discharged through a flow channel of the anode separator.

The present disclosure will be described in further detail below using Examples and Comparative Examples. However, the present disclosure is not limited to the Examples.

### Examples 1 to 3 and Comparative Examples 1 to 3

A membrane electrode assembly (MEA) was fabricated in which an electrolyte membrane formed of a perfluorocarbon sulfonic acid polymer is sandwiched between an anode electrode that causes an oxygen evolution reaction and a cathode electrode that causes a hydrogen evolution reaction. Specifically, a catalyst and a perfluorocarbon sulfonic acid polymer (equivalent weight (EW): 1100) based on Nafion (manufactured by Chemours) as a polymer having ion exchange groups (ionomer or binder) were dispersed and mixed, and the resulting mixture was applied to both sides of an electrolyte membrane to form a cathode catalyst layer and an anode catalyst layer. The cathode catalyst layer, the electrolyte membrane, and the anode catalyst layer were then bonded by hot pressing at 145° C. and 3 MPa to fabricate the membrane electrode assembly. In each of Examples 1 to 3 and Comparative Examples 2 and 3, vapor-grown carbon fibers (VGCFs) as a fibrous material were additionally mixed into the cathode catalyst layer in a predetermined amount. The content of the fibrous material in each of the Examples and Comparative Examples is shown in Table 1. As used herein, the content of the fibrous material refers to the proportion of the mass of the fibrous material to the total mass of the cathode catalyst and the fibrous material.

Elyst Ir75 (iridium oxide catalyst) manufactured by Umicore was used as the anode catalyst. A Pt-supported carbon having a Pt loading of 10 wt % to 50 wt %, synthesized by a known method, was used as the cathode catalyst.

A gas diffusion layer substrate formed of carbon fibers (GDL 22BB, manufactured by SGL) and a gas diffusion layer formed of a microporous layer containing carbon particles and a water repellent were disposed on the outer side of the cathode electrode. A gas diffusion layer formed of porous titanium was disposed on the outer side of the anode electrode. A membrane electrode-gas diffusion layer assembly was thus fabricated.

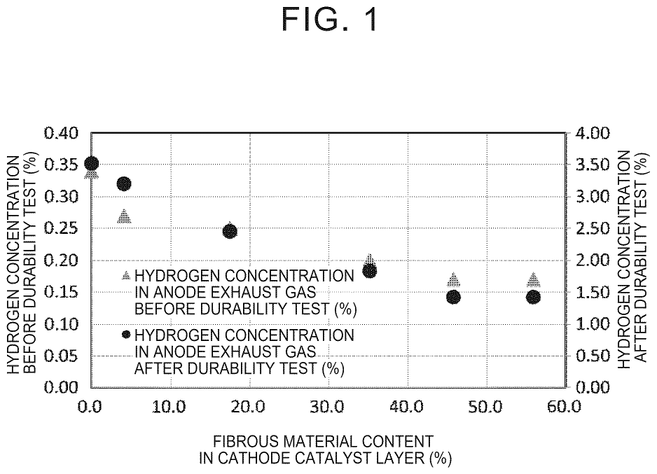

The fabricated membrane electrode-gas diffusion layer assembly (with an electrode area of 1 cm²) was used, and I-V characteristics were obtained by controlling the current while ultrapure water was supplied to the anode. The cell temperature was set to 50° C., and the pressure was set to atmospheric pressure. Thereafter, an accelerated durability test was conducted at 95° C. by repeating 3600 cycles of potential cycling between 0.0 V (shutdown) and 1.8 V (startup) with a hold time of 10 s at each potential. Subsequently, I-V characteristics were obtained again by controlling the current under the same conditions as before the accelerated durability test. The hydrogen concentration in the anode exhaust gas was measured both before and after the accelerated durability test. The voltage before the accelerated durability test was defined as the initial voltage, and the rate of degradation (%) was calculated as the proportion of the voltage after the durability test to the initial voltage (((voltage after durability test−initial voltage)/initial voltage)×100). The results are shown in Table 1. The relationship between the content of the fibrous material in the cathode catalyst and the hydrogen concentrations in the anode exhaust gas before and after the durability test is shown in FIG. 1.

TABLE 1

| | | Hydrogen | Hydrogen | |
|---|---|---|---|---|
| | | Concentration in | Concentration in | |
| | Fibrous | Anode Exhaust | Anode Exhaust | Rate of |
| | Material | Gas Before | Gas After | Degrada- |
| | Content | Durability Test | Durability Test | tion |
| | (%) | (%) | (%) | (%) |
| Example 1 | 35.2 | 0.20 | 1.83 | 32 |
| Example 2 | 45.8 | 0.17 | 1.42 | 31 |
| Example 3 | 55.9 | 0.17 | 1.42 | 30 |
| Comparative | 0 | 0.34 | 3.52 | 35 |
| Example 1 | | | | |
| Comparative | 4.1 | 0.27 | 3.20 | 34 |
| Example 2 | | | | |
| Comparative | 17.5 | 0.25 | 2.45 | 34 |
| Example 3 | | | | |

As shown in Table 1 and FIG. 1, in Examples 1 to 3 in which the content of the fibrous material was within the range of 35.0% to 60.0%, the hydrogen concentrations in the anode exhaust gas before and after the durability test were lower than those in Comparative Examples 1 to 3 in which the content of the fibrous material was outside the above range, suggesting that hydrogen permeation to the anode was suppressed. The rate of degradation was also lower in Examples 1 to 3. This is considered to be due to the fact that hydrogen diffusion in the cathode was promoted.

What is claimed is:

1. A cathode catalyst layer included in a water electrolysis cell, the cathode catalyst layer comprising:
a cathode catalyst; and
a fibrous material,
wherein a proportion of mass of the fibrous material to total mass of the cathode catalyst and the fibrous material is 35.0% to 60.0%.

2. The cathode catalyst layer according to claim 1, wherein the fibrous material is carbon fibers.

3. The cathode catalyst layer according to claim 1, wherein the cathode catalyst contains platinum.

4. A membrane electrode assembly for a water electrolysis cell, the membrane electrode assembly comprising:
an electrolyte membrane;
an anode catalyst layer laminated on a first surface of the electrolyte membrane; and
the cathode catalyst layer according to claim 1, the cathode catalyst layer being laminated on a second surface of the electrolyte membrane.

5. The membrane electrode assembly according to claim 4, wherein the electrolyte membrane has a thickness of 20 μm or less.
